(19) United States
(12) Patent Application Publication
(10) Pub. No.: US 2007/0188847 A1
(43) Pub. Date: Aug. 16, 2007

(54) MEMS device and method

(75) Inventors: William Craig McDonald, Allen, TX (US); Armando Gonzalez, Allen, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/353,473

(22) Filed: Feb. 14, 2006

(51) Int. Cl. G02B 26/00

(52) U.S. Cl. 359/291

(57) ABSTRACT

A micro-mirror hinge assembly for use in a MEMS device such as a DMD, and method. In a preferred embodiment, a first hinge member is mounted to a substrate by one or more via structures that may be integrally-formed with the hinge-member to facilitate torsional deformation. A second hinge member also configured for torsional deformation is mounted to and usually above the first hinge member so that deformation of the second hinge member occasions deformation of the first. Additional hinge members, each mounted to at least one other hinge member, may also be present. A mirror or similar reflecting surface is mounted to the second hinge member at one or more mirror vias. The MEMS device may include means for selectively inducing mirror reorientation, which in turn causes deformation in the hinge members of the hinge assembly.

### TECHNICAL FIELD

The present invention relates generally to the field of MEMS applications, such as projection display systems and laser copiers, and more particularly to a DMD using a stacked-hinge configuration.

### BACKGROUND

MEMS, or micro electromechanical systems, are used, for example, to create an image in popular electronic products such as projection displays and laser printers. In these exemplary applications, the MEMS component modulates light received from a light source and traveling along an optical path, altering the characteristics of the light beam to produce an image. (For this reason, a MEMS of this type may be called an ‘optical’ MEMS, initialized ‘MOEMS’.) A projection display, for example, may be used for displaying a visual image for viewers of a high-definition television (HDTV). One such projection display system is marketed in connection with the name Digital Light Processing®, or DLP®, available from Texas Instruments Incorporated of Dallas, Tex. This application will now be briefly described.

In order to produce a visual image on an exemplary HDTV, light from a light source is processed by a series of components. FIG. 1 is a simplified block diagram illustrating a projection display system optical path 10 using one such series of components. The MEMS device used in this projection display system is a DMD (digital micro-mirror device). Light from a light source 11, which may be an arc lamp or an LED, is collimated and directed along a first portion 21 of the optical path 10. A color wheel 13 is used to produce selectively-colored light for producing colored images. The condenser lenses 12 and 14 shape the beam of light as it propagates along the first portion 21 of optical path 10. The selectively-colored light eventually falls on the DMD 15, where it is transformed into a visual image. The visual image created by DMD 15 is directed to a second portion 22 of the optical path 10. In FIG. 1, second optical path portion 22 includes a display screen 19, which may, for example, be an HDTV screen, presents the visual image display intended to be seen by the viewer. The projection lens 18 enlarges the image created by DMD 15 so it will fit the display screen 19. The DMD 15 will now be described in more detail.

FIG. 2 is a plan view of a portion of the DMD 15 shown in FIG. 1. Here it can be seen that the DMD is actually composed of a number of mirrored surfaces (often referred to as micro-mirrors); in FIG. 2 these are numbered 24 through 29. (The partially-shown micro-mirrors are not numbered.) In the DMD 15 of FIG. 2, each mirror 24 through 29 has a via, numbered 30 through 35 respectively, which is used to connect the mirror to a structure beneath it (as will be described below). While only six micro-mirrors are (fully) shown in FIG. 2, a typical DMD such as DMD 15 may include on the order of thousands of them, or even one million such structures or more. Each of these micro-mirrors is individually controllable to rapidly change orientation, which determines whether the mirror surface does or does not reflect light at a given time toward the second portion 22 of the optical path 10 (shown in FIG. 1). Light not so reflected may instead be directed toward a light dump (not shown) where it is absorbed rather than reflected further to create potential interference problems.

FIG. 3 is the DMD 15 of FIG. 2 with micro-mirror 28 removed to reveal the various structures underneath. These underlying structures include two important features. First, a reorientation assembly 37 includes those components necessary to facilitate mirror reorientation for the selective light reflection described above. These components include one or more control electrodes, here a first electrode 38 and a second electrode 39, to which electrical charges are selectively applied to attract or repel a corresponding mirror edge or corner (not shown in FIG. 3), causing the micro-mirror to move from one orientation to another. Electrostatic attraction between the micro-mirror 28 and one or the other of these electrodes causes the mirror to reorient in either of two directions because of the manner in which it is mounted, as described below.

The other important feature of reorientation assembly 37 is the torsion hinge 40. When prompted by the control electrodes, for example, the micro-mirror 28 rotates substantially about an axis defined by a torsion hinge 40. Typically, the mirror rotates about torsion hinge 40 until the rotation is mechanically stopped (that is, until it reaches the end of its travel). The micro-mirror 28 in this way is oriented into an “on” or “off” state by electrostatic forces that are determined by data written to a memory cell, for example a CMOS static RAM cell (not shown). The tilt of the mirror may, for example, be on the order of plus 10 degrees (on) or minus 10 degrees (off) to modulate the light that is incident on the surface. In a typical DMD the micro-mirrors are operable to reorient many times per second.

Torsion hinge 40 includes a torsion beam 41 that is integrally formed between hinge support 42 and hinge support 43. As can be seen in FIG. 3, torsion beam 41 widens at approximately its center 44 so as to accommodate the mounting of micro-mirror 28 using mirror via 34 (see FIG. 2). This mounting, which may be accomplished when the mirror via 34 is formed, attaches the micro-mirror 28 to the torsion hinge 40 such that movement of the mirror causes torsional deformation in the hinge, which otherwise substantially holds the mirror in its place in DMD 15. The mirror via 34 also supports micro-mirror 28 in a spaced-apart relationship above torsion hinge 40, permitting mirror reorientation. Torsion hinge 40 is similarly mounted by hinge vias 44 though 46 formed in hinge support 42 and hinge vias 47 through 49 formed in hinge support 43. The torsion hinge 40 is therefore supported in a spaced-apart relationship to the substrate 36 beneath it.

FIG. 4 is an orthographic view of a typical micro-mirror hinge assembly 50 showing the positioning of a micro-mirror 51 relative to its associated hinge 54. Approximately one-half of micro-mirror 51 has been cut away to more clearly show the structure. Hinge 54 is substantially similar though not necessarily identical in construction to hinge 40 shown in FIG. 3. In FIG. 4 it should be apparent that the mirror via 53 lies approximately in the center of the reflecting surface 52 of micro-mirror 51. Mirror via 53 is typically fabricated integrally with the main portion of mirror 51, with some of the mirror-layer material being deposited in a recess previously formed in the layer of spacer material immediately below the mirror layer. As the mirror-layer material is deposited, the material in the spacer-layer recess bonds with the material of the hinge 54 in approximately the center 56 of the hinge torsion beam 55. An adhesive may be used for mounting as well. Note that hinge beam 55 is the portion of hinge 54 that undergoes torsional deformation in order to allow micro-mirror 51 to reorient.

Hinge 54 is, in this example, anchored at both ends by hinge supports 57 and 58. As with hinge supports 42 and 43 shown in FIG. 3, these hinge supports 57 and 58 each form several vias on which the hinge is mounted. Hinge support 57 forms vias 59 through 61, and hinge support 58 forms vias 62 through 64, which each extend to the substrate (not shown in FIG. 4) to which they are fixedly mounted. In hinge 54, each hinge support forms three such vias, although the exact number used is a matter of design choice. As should be apparent, when micro-mirror 51 reorients, the hinge torsion beam 55 flexes to allow the movement. The greatest deformation, of course, occurs in the center 56 of beam 55 and the amount of deformation decreases as the distance from the center 56 increases. Depending on the hinge design and the range of motion of the micro-mirror 51, the hinge supports 57 and 58 may or may not experience any significant deformation.

FIG. 5 is a simplified cross-section of the micro-mirror hinge assembly 50 as viewed along section line 5-5 shown in FIG. 4. In FIG. 5, the mounting of micro-mirror 51 to hinge 54 at mirror via 53 may be seen. Hinge torsion beam 55 extends between the hinge supports 57 and 58, and specifically between hinge vias 60 and 63 where the hinge is fixedly mounted to the substrate 65. As mentioned above, mirror via 53 is mounted to hinge 54 at approximately the center 56 of hinge torsion beam 55. Hinge-support vias 60 and 63 are shown at the hinge supports 57 and 58 at respective ends of hinge torsion beam 55, although the remaining vias (see FIG. 4) are omitted in FIG. 5 for clarity. Note that as used herein, the hinge support “anchors” of a hinge member denote the portions used to fix the ends of the hinge. It is not imperative, however, that a definite boundary exist between the supports and torsion beam or that the beam deforms along its entire length or that the anchor does not deform at all as the micro-mirror reorients. Rather, these properties will vary somewhat by design.

In general, however, each hinge member may be expected to deform more significantly at points further from an anchor point, and closer to the points where the deforming force is translated to the hinge. In the hinge 54 of FIG. 5, it may also be observed that the deformation experienced in hinge torsion beam 55 occurs substantially about the axis labeled X₁-X₁. The deformation is described as “substantially” occurring because there may well be some lateral or vertical component to the hinge deformation as well. Notwithstanding the forgoing, the assembly of FIG. 5 may be referred to as a single-axis micro-mirror hinge assembly.

The micro-mirror hinge assembly configuration described above is a proven and successful design, but limitations have been encountered. Most notably, there is a maximum hinge compliance that is attainable given current component dimensions, and reducing these dimensions (to increase compliance) is difficult in light of current fabrication processes. There is also, with the configuration of FIG. 5, a risk of thermal buckling due to a difference in the respective coefficients of thermal expansion that may exist in the material of the hinge and that of the substrate. There is, therefore, a need in the industry for a DMD with an improved micro-mirror hinge assembly having a higher compliance that can be achieved using hinges of existing dimension, especially if the new design could reduce the risk of thermal buckling. Embodiments of the present invention provides a novel solution for providing such a MEMS device with these desirable characteristics.

### SUMMARY OF THE INVENTION

These and other problems are generally solved or circumvented, and technical advantages are generally achieved, by preferred embodiments of the present invention, which are directed to a MEMS (micro electromechanical system) device such as a DMD (digital micro-mirror device) having a plurality of micro-mirrors, each supported by a stacked hinge assembly.

In one aspect, the present invention is a DMD that includes a plurality of selectively-orienting micro-mirrors that are operable to modulate light from a received light beam to create an image. The mirrors each are mounted on a stacked-hinge assembly that includes a first hinge member mounted to a substrate at one or more hinge vias and a second hinge member that is mounted to the first hinge member. The second hinge member may also be mounted by one or by a number of vias. In accordance with a preferred embodiment of the present invention, the first hinge member is mounted to the substrate at a single hinge via and the second hinge member is mounted to the first hinge member at a plurality of hinge vias. In this embodiment, the mirror is mounted to the second hinge member at a single mirror via.

In another aspect, the present invention is a projection display system that includes a light source and a display screen defining the ends of an optical path that includes a DMD having a plurality of micro-mirrors. Each mirror of the plurality of micro-mirrors is mounted on a hinge assembly that includes a first hinge member deformable about a first torsion axis and a second hinge member deformable about a second torsion axis. The hinge assembly is mounted to a substrate such that reorientation of the mirror mounted upon it causes torsional deformation about the first and second axes.

In yet another aspect, the present invention is a method of fabricating a micro-mirror hinge assembly including the steps providing a substrate, forming micro-mirror control circuitry on the substrate, forming a first hinge member mounted to the substrate, forming a second hinge member mounted to the first hinge member, and forming a mirror mounted to the second hinge member. The micro-mirror hinge assembly thus formed is, in a preferred embodiment, formed in a DMD having a plurality of micro-mirror hinge assemblies, wherein the same process step is used to fabricate a given component for each of the micro-mirror hinge assemblies in the plurality.

An advantage of a preferred embodiment of the present invention is that it increases DMD hinge compliance without having to effect a reduction in hinge-member dimensions when compared to designs currently in use. By the same token, the present invention may be used where increase in the size of the hinge components without overall reducing hinge compliance is sought.

A further advantage of a preferred embodiment of the present invention is, at least in some embodiments, the risk of thermal buckling is mitigated or avoided because the first hinge member of the hinge assembly is mounted to the substrate at a single hinge via.

A more complete appreciation of the present invention and the scope thereof can be obtained from the accompanying drawings that are briefly summarized below, the following detailed description of the presently-preferred embodiments of the present invention, and the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 is a simplified block diagram illustrating selected components of a projection display system optical path;

FIG. 2 is a plan view of a portion of the DMD shown in FIG. 1;

FIG. 3 is the DMD of FIG. 2 with a micro-mirror removed to reveal the various structures that are disposed underneath;

FIG. 4 is an orthographic view of a typical micro-mirror hinge assembly showing the positioning of a micro-mirror relative to its associated hinge;

FIG. 5 is a simplified cross-section elevation view of the micro-mirror hinge assembly of FIG. 4 as viewed along the section line 5-5;

FIG. 6 is a cross-sectional elevation view of a micro-mirror hinge assembly according to an embodiment of the present invention;

FIG. 7 is a simplified plan view of the micro-mirror hinge assembly of FIG. 6;

FIG. 8 is a cross-sectional elevation view of micro-mirror hinge assembly according to another embodiment of the present invention;

FIG. 9 is a simplified plan view of the micro-mirror hinge assembly of FIG. 8;

FIGS. 10a and 10b are, respectively, front and side views of a micro-mirror hinge assembly according to another embodiment of the present invention. FIG. 10c is an orthographic view of this hinge assembly without the mirror; and

FIG. 11 is a flow diagram illustrating a method for fabricating a DMD according to an embodiment of the present invention.

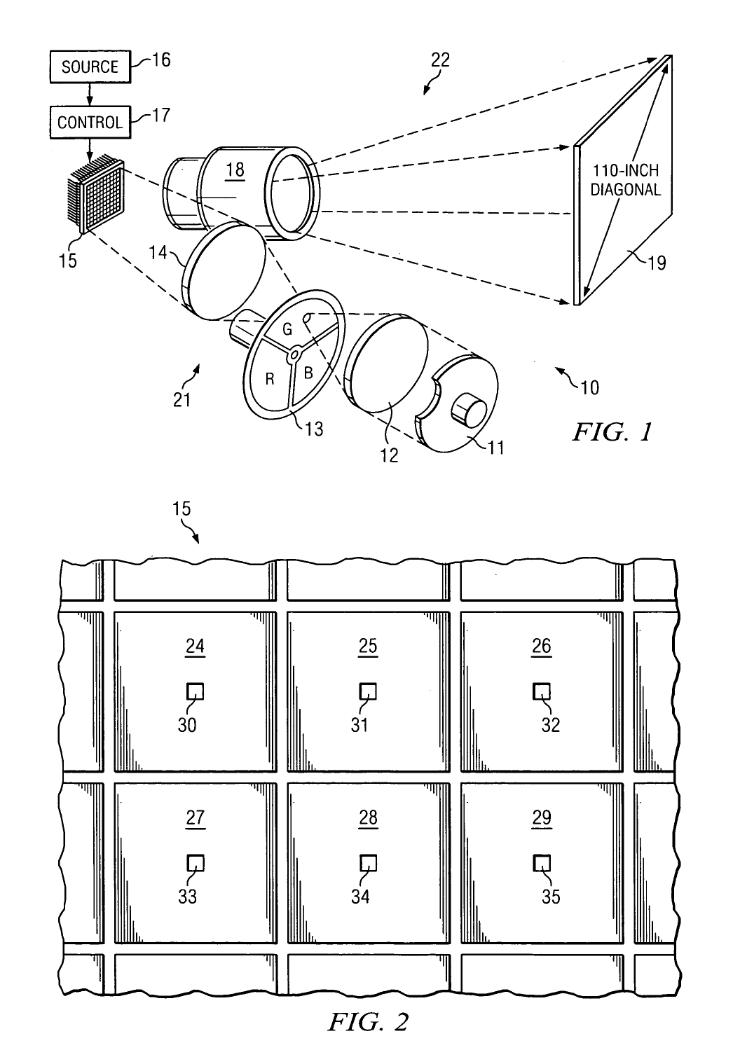

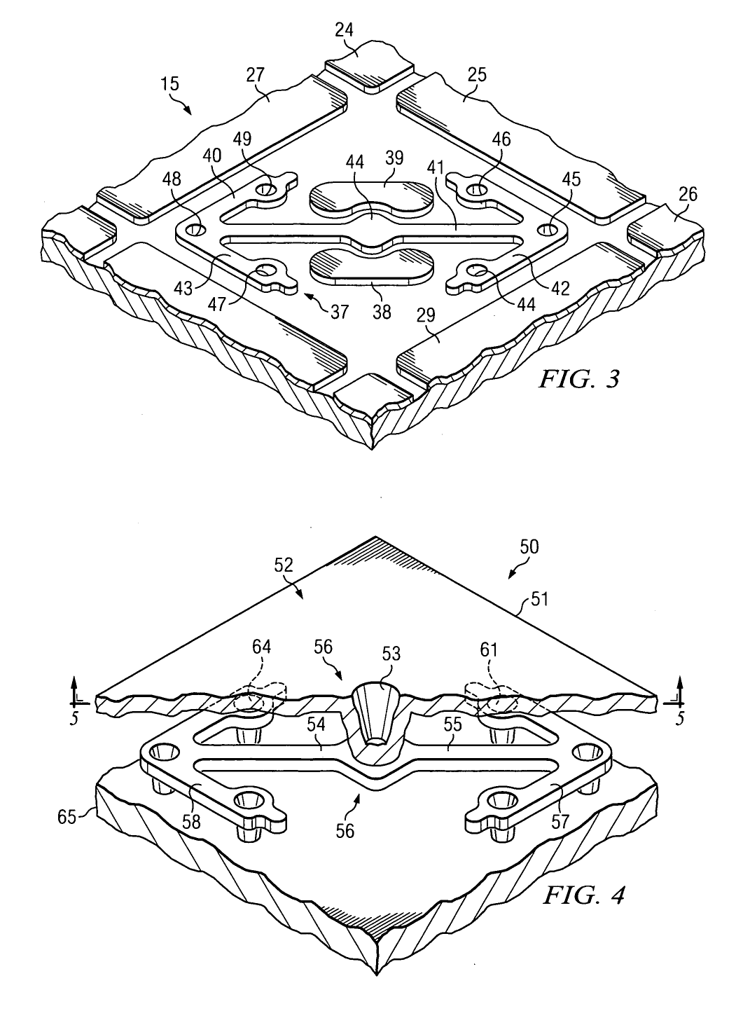

### DETAILED DESCRIPTION OF ILLUSTRATIVE EMBODIMENTS

Presently preferred embodiments of the present invention and their implementation are discussed in detail below. It should be appreciated, however, that the present invention provides many applicable inventive concepts that can be embodied in a wide variety of specific contexts. The specific embodiments discussed are merely illustrative of specific ways to make use of the invention, and do not limit the scope of the invention.

The present invention will be described with respect to preferred embodiments in a specific context, namely a micro-mirror hinge assembly for a DMD (digital micro-mirror device) for use in a projection display system. The invention may also be applied, however, in other MEMS applications as well, for example in laser printers.

As described above, applications such as DLP® projection display systems employ a spatial light modulator (SLM) such as a DMD. The ability of the DMD to modulate light in such a system depends largely on the movement of a number of very small reflecting surfaces, often called micro-mirrors. Each micro-mirror is individually controllable to rapidly adjust its orientation with respect to a beam of incident light in order to create an image for visual display. Note that as used herein, the term ‘reorientation’is used to refer to a change in the angle of orientation of the (substantially planar) reflecting surface of an individual micro-mirror. Although this reorientation does not imply a lateral shift in position, some lateral or vertical movement may (or may not) occur as the micro-mirror reorients.

Reorientation of the micro-mirror is currently facilitated by the torsional deformation of a hinge to which the mirror is attached. The movement itself is typically induced by a pair of alternately-charged electrodes according to received instructions, but the hinge allows reorientation when so induced while also ensuring that lateral movement stays within acceptable limits. To overcome the hinge compliance limitations of the present hinge structures, however, embodiments of the present invention use a hinge-assembly that will now be described in more detail.

FIG. 6 is a cross-sectional elevation view of a micro-mirror hinge assembly 100 according to an embodiment of the present invention. In this embodiment micro-mirror hinge assembly 100 includes a micro-mirror 115 and a hinge assembly 102, which has a first hinge member 105 and a second hinge member 110. First hinge member 105 is mounted to the substrate 101 at a single hinge via 106. For convenience in describing embodiments of the present invention, the hinge member described as ‘first’ will be the one mounted to the substrate. The substrate 101 may be the base substrate of a semiconductor wafer, or may be a higher level layer that is disposed above other previously-fabricated layers. The mounting via 106 attaches the first hinge member 105 to the substrate. Although the exact nature of this attachment may vary somewhat according to the specific application and the materials used, in general via 106 provides an anchor for the torsional movement of the remainder of the first hinge member 105.

In the embodiment of FIG. 6, the impetus for this torsional movement will be translated through the second hinge member 110. Second hinge member 110 is mounted to first hinge member 105 by hinge via 111 and hinge via 112. Movement in the second hinge member 110 is in turn caused by movement of the micro-mirror 115 and translated to the second hinge member 110 through mirror via 116. As mentioned above, this movement is caused by the reorientation of the micro-mirror 115 as typically induced by one or more control electrodes (not shown in FIG. 6) during operation of the device.

The torsional movement of the first hinge member 105 occurs as the hinge vias 111 and 112 move toward and away from the viewer of FIG. 6. The top of the vias will move more than the bottom because the first hinge member 105 is anchored to the substrate 101 approximately in the center of its length at hinge via 106. Note that a central location for hinge via 106 is presently preferred but not required. Hinge via 106 will substantially if not totally inhibit the torsional (rotational) motion of the first hinge member 105 at the location of the hinge via 106. By the same token, the first hinge member 105 will torsionally deform, that is ‘twist’, to an increasing extent as the distance from hinge via 106 increases. Note that the exact shape of the deformed member will vary according to design, and no definite deformation profile is required or implied.

As first hinge member 105 deforms torsionally, some, although usually not a great deal of lateral and vertical bending may also occur, meaning that the first axis of torsional deformation Y₁-Y₁ may not be absolutely straight or unmoved during reorientation. Similarly, the second hinge member 110 rotates substantially about the second axis of torsional deformation Y₂-Y₂ between hinge via 111 and hinge via 112, by which second hinge member 110 is mounted to first hinge member 105. As should be apparent, there will be some lateral and vertical movement of axis Y₂-Y₂ as well, due in part to the torsional deformation of first hinge member 105 about axis Y₁-Y₁.

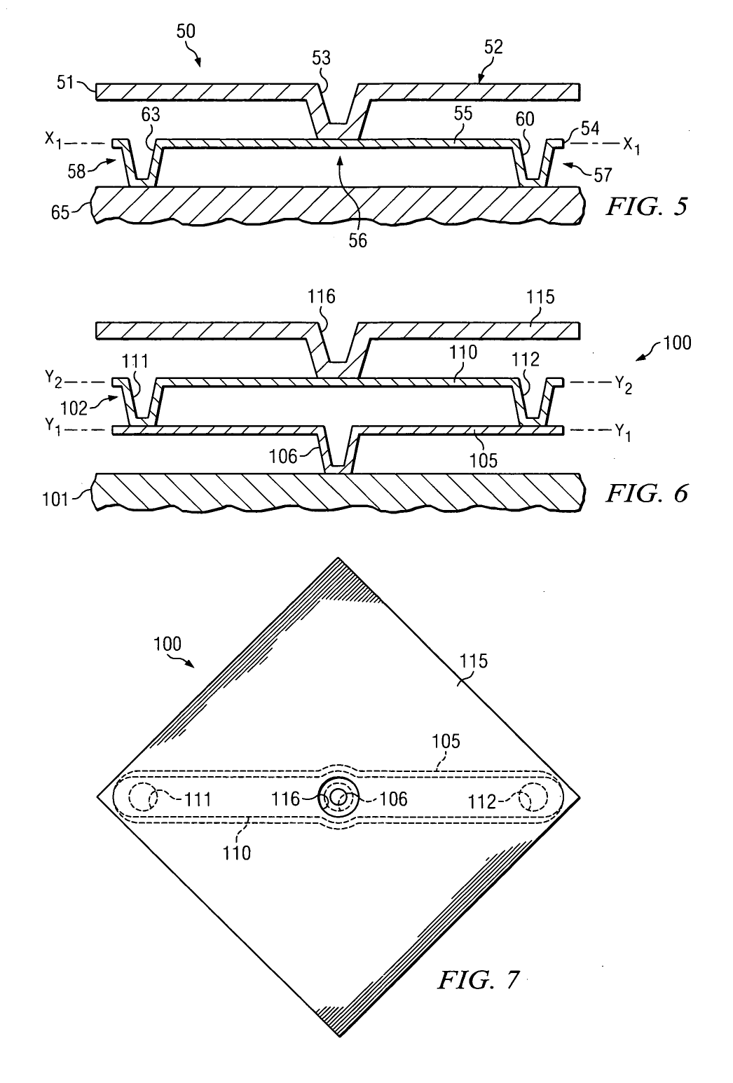

The hinge assembly 102 described above in reference to FIG. 6 may be referred to as a double-axis torsional hinge assembly, because torsional deformation about two independent axes of deformation is facilitated. In the embodiment of FIG. 6, the hinge assembly may also be referred to as a stacked-hinge assembly, because the second axis Y₂-Y₂ lies generally above the first axis Y₁-Y₁ and the hinge members defining these axes are attached to each other. This configuration means, other factors being equal, that the hinge assembly 102 is in the aggregate more compliant than hinge configurations of the prior art (such as the one shown in FIG. 5), notwithstanding the fact that its hinge members are subject to the same minimum-size constraints as current hinges. If desired, of course, the size of the hinge members configured according to an embodiment of the present invention could be increased while maintaining current compliance characteristics. In addition, in the embodiment of FIG. 6 the problem of thermal buckling is reduced if not completely avoided. This is because first hinge member 105 is mounted to the substrate 101 at only a single hinge via 106, which substantially negates the effect of the differences in thermal coefficients between the hinge and the substrate.

FIG. 7 is a simplified plan view of the micro-mirror hinge assembly 100 of FIG. 6. In FIG. 7 the micro-mirror 115 and the location of mirror via 116 are clearly visible. The first hinge member 105 and the second hinge member 110 and their respective via features are shown by broken line. For example, the location of hinge via 111 and hinge via 112 are shown near opposite corners of the micro-mirror 115. First hinge member 105 is for convenience shown slightly wider than the second hinge member 110 above it. The hinge via 106 associated with the first hinge member 105 is depicted beneath mirror via 116. Note that the shapes and relative sizes of the hinge members and the mounting vias are exemplary and not intended to be limiting.

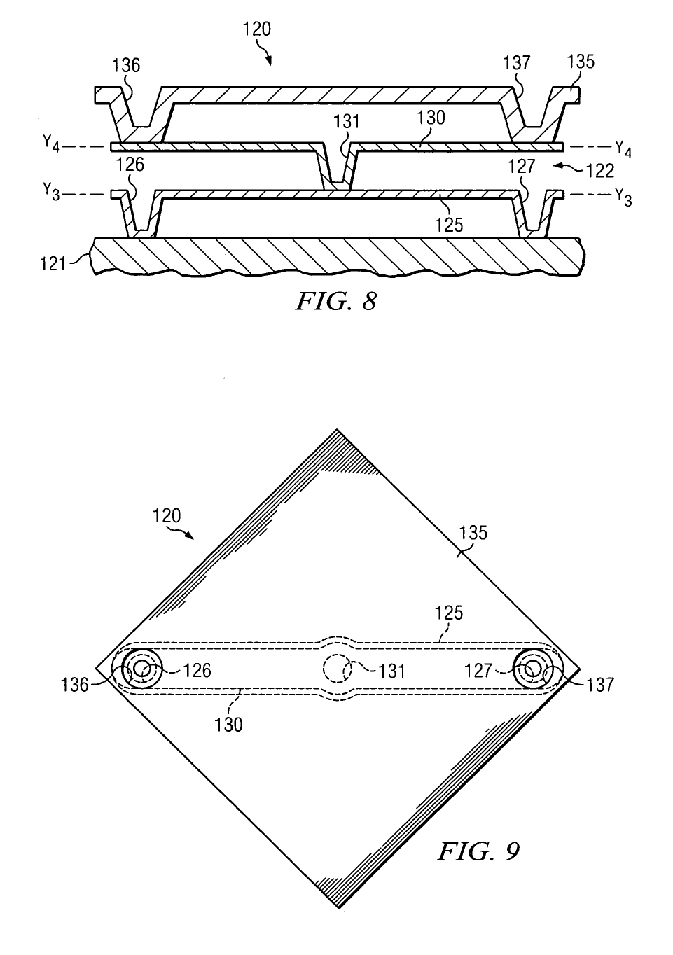

FIG. 8 is a cross-sectional elevation view of micro-mirror hinge assembly 120 according to another embodiment of the present invention. Micro-mirror hinge assembly 120 includes mirror 135 and hinge assembly 122. Hinge assembly 122 is also a stacked-hinge configuration, but in this embodiment first hinge member 125 is mounted to the substrate 121 at two locations by hinge via 126 and hinge via 127, respectively. This means that torsional deformation during mirror reorientation will substantially occur between these two hinge vias about an axis of torsional deformation Y₃-Y₃. The second hinge member 130 of hinge assembly 122, in contrast, is mounted to a central location of first hinge member 125 at hinge via 131, and will deform at or near its ends substantially about a second axis of torsional deformation Y₄-Y₄. Again, there may be some lateral and vertical movement of axis Y₃-Y₃, and even more with respect to axis Y₄-Y₄.

FIG. 9 is a simplified plan view of the micro-mirror hinge assembly 120 of FIG. 8. In FIG. 9 the micro-mirror 135 and the location of mirror vias 136 and 137 are clearly visible. Mirror 135 forms two vias, preferred in this configuration because of the central location of hinge via 131 central to the second hinge member 130. This is not a requirement unless explicitly stated, however, or apparent from the context. As with the previously described embodiment, the shapes and relative sizes of the hinge members and the mounting vias are exemplary and not limiting.

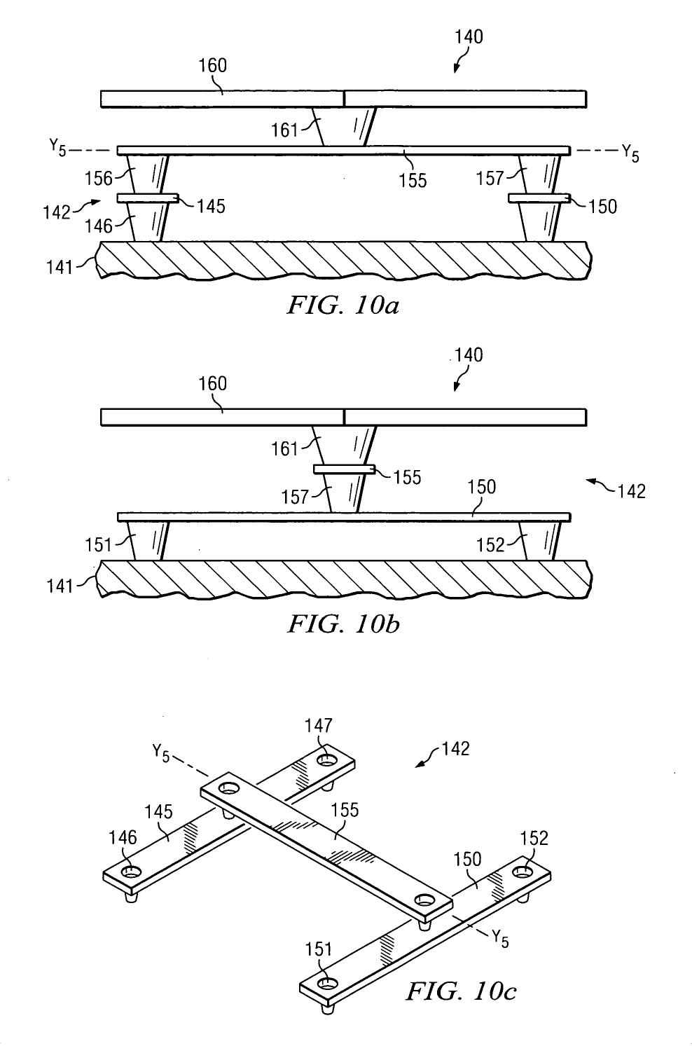

FIGS. 10a and 10b are, respectively, front and side views of a micro-mirror hinge assembly 140 according to another embodiment of the present invention. (Note that the views designated ‘front’ and the ‘side’ are arbitrarily chosen.) In this embodiment, hinge assembly 142 includes two hinge members, a first hinge member 145 and a second hinge member 150 that are mounted to the substrate 141. The first hinge member 145 forms hinge via 146 and hinge via 147 for this purpose, while the second hinge member 150 forms vias 151 and 152. The third hinge member 155 of hinge assembly 142 is mounted near one end at hinge via 156 and near the other end at hinge via 157. Hinge vias 156 and 157 mount the third hinge member 155 to, respectively, first hinge member 145 and second hinge member 150. Mirror 160 is mounted central to the third hinge member 155 at via 161. FIG. 10c is an orthographic view of the hinge assembly 142 without the mirror 160. Note that while this is still considered to be a stacked-hinge design, there is typically only a single identifiable axis of rotation Y₅-Y₅. Additional compliance is expected, however, given that the first and second hinge members will deform somewhat as the third hinge member 155 rotates about axis Y₅-Y₅. Other stacked-hinge configurations, of course, are possible.

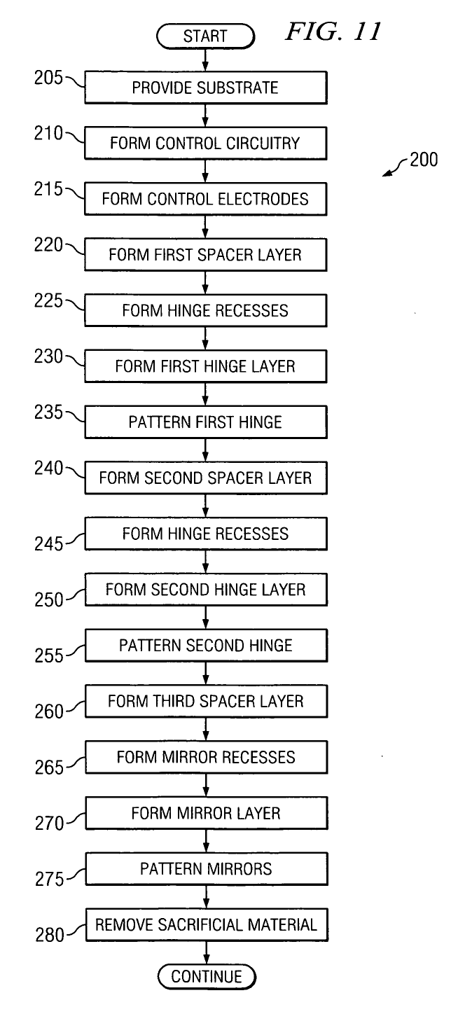

FIG. 11 is a flow diagram illustrating a method 200 for fabricating a DMD according to an embodiment of the present invention. At START it is presumed that the materials and equipment necessary to fabrication are available and operational. This being the case, the process begins with providing a substrate (step 205). The substrate, generally a semiconductor wafer substrate, may be of silicon or some other suitable material. In any semiconductor application, of course, the various devices involved are formed using a series of layers. The method 200 need not begin with a wafer onto which no other layers have been formed, and so as used herein the term substrate will refer to the base substrate or to the then ‘top’ layer on which the MEMS device such as a DMD is to be fabricated.

Control circuitry is then formed (step 210). The exact configuration of the control circuitry is not material to embodiments of the present invention, but is expected to be operative for causing mirror reorientation as required for the device to function. This will typically include a memory device connectable to a driver or controller. Control electrodes are also formed (step 215), although again it is not material whether they are formed along with or separately from the control circuitry. Other mechanisms for controlling the micro-mirror operation are also permissible.

At this point, a first spacer layer is deposited (step 220). In most applications the first spacer layer is formed of a sacrificial material. That is, of a material suitable for supporting fabrication of the layers above it but eventually removable. Any material that permits operation of the hinge assembly may, however, be used. At least one hinge via recess is then formed in the first spacer layer (step 225). The hinge layer of a suitable hinge material may then be formed (step 230). This layer will normally be deposited in such a manner that the material fills at least partially the previously-formed hinge via or vias. Physical contact is thereby made with the substrate, that is, the underlying non-sacrificial layer. As should be apparent, the via or vias become the mounting for the hinge when it is formed. Note that while structures called vias are now in use, there is implied here no restriction on the shape or relative size of a via used to mount a hinge or other component except that it must be able to functionally support the component during operation of the device.

The first hinge may now be patterned (step 235). This may, for example, be performed using a photolithography operation. In any case, the effect is to leave mounted in place the first hinge structure of the hinge assembly of the embodiment of the present invention. A second spacer layer is then formed (step 240), and then one or more vias formed within it (step 245). At this point, using a similar though not necessarily identical series of steps the second hinge layer is formed (step 250) and the second hinge structure is patterned (step 255). This leaves a first hinge mounted to the substrate and a second hinge mounted to the first hinge. Additional hinge layers may be added as well, mounted by vias or similar structures, but this is not presently preferred.

Following the formation of the hinge assembly, as described above, a third spacer layer is formed (step 260). One or more mirror via recesses are then formed in the third spacer layer (step 265) and a mirror layer deposited (step 270). As seen, for example, in FIGS. 6 and 8, the mirror via is typically larger than the hinge vias, though this is not a requirement. In addition, it is noted that no certain materials or even material properties are required for the hinge layer unless explicitly recited. Once the mirror layer is formed, the individual mirror or mirrors may be patterned (step 275). At this point, any remaining sacrificial material may be removed (step 280). The fabrication process may then continue according to standard fabrication practice and be installed in the optical path of a MEMS system.

It is noted that in describing the method 200, embodiments of the present invention may encompass the fabrication of only a single mirror hinge assembly. This is generally not the case, however, as typical DMD MEMS devices often require the fabrication of thousands of such assemblies. Unless stated, however, there is no requirement that each of the mirrors on the device be identically constructed, or even that they all be constructed according to an embodiment of the present invention. For example, it may in some instances be desirable to have some of the mirror hinge assemblies constructed according to the prior-art configurations.

Although the present invention and its advantages have been described in detail, it should be understood that various changes, substitutions and alterations can be made herein without departing from the spirit and scope of the invention as defined by the appended claims. For example, the number and locations of the vias used to mount components to each other may be varied, and do not need to be the same for each micro-mirror hinge assembly in a given system. And although the hinge members of the embodiments described above are shown as either parallel or perpendicular to the other member or members within an assembly, other angles may be used as well.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A digital micro-mirror device (DMD), comprising a plurality of micro-mirrors, each micro-mirror of the plurality of micro-mirrors mounted on a stacked-hinge hinge assembly.

2. The DMD of claim 1, wherein the stacked-hinge assembly comprises a first hinge member that is capable of torsion flexing about a first axis, the first hinge member mounted on a second hinge member that is capable of torsion flexing about a second axis.

3. The DMD of claim 2, wherein the first axis and the second axis are substantially parallel when the micro-mirror is neutrally oriented.

4. The DMD of claim 2, further comprising a third hinge member mounted on the second hinge member.

5. The DMD of claim 2, wherein the first hinge member is mounted to the second hinge member at a plurality of vias.

6. The DMD of claim 1, wherein the plurality of micro-mirrors comprises all of the micro-mirrors of the DMD.

7. The DMD of claim 1, wherein each micro-mirror of the plurality of micro-mirrors is separately controllable.

8. The DMD of claim 1, wherein the stacked-hinge assembly comprises a first hinge member and a second hinge member mounted to a substrate and a third hinge member mounted to both the first hinge member and to the second hinge member.

9. The DMD of claim 1, wherein the stacked hinge assembly is mounted to a substrate at a single hinge via.

10. A hinge assembly for a micro-mirror device, comprising:
a first torsion hinge; and
a second torsion hinge mounted to the first torsion hinge, wherein the second torsion hinge is generally above the first torsion hinge.

11. The hinge assembly of claim 10, wherein the first torsion hinge is mounted to the substrate of a semiconductor wafer.

12. The hinge assembly of claim 11, wherein the first torsion hinge is mounted to the substrate by a single hinge via.

13. The hinge assembly of claim 10 further comprising a mirror mounted to the second torsion hinge.

14. The hinge assembly of claim 13, wherein the mirror is mounted to the second torsion hinge by at least one mirror via.

15. The hinge assembly of claim 10, wherein the second torsion hinge is mounted to the first torsion hinge by at least one hinge via.

16-24. (canceled)

25. A micro-mirror hinge assembly, comprising:
a substrate having a top surface;
a first hinge member mounted on the top surface of the substrate;
a second hinge member mounted to the first hinge member, wherein the second hinge member is generally above the first hinge member; and
a micro-mirror rotatably mounted to the second hinge member.

26. The micro-mirror hinge assembly of claim 25, wherein the substrate comprises a semiconductor material.

27. The micro-mirror hinge assembly of claim 25, wherein the first hinge member is mounted to the substrate by a single via.

28. The micro-mirror hinge assembly of claim 25, wherein the second hinge member is mounted to the first hinge member by at least one via.

29. The micro-mirror hinge assembly of claim 25, wherein movement of the micro-mirror causes movement of the second hinge member, and movement of the second hinge member causes movement of the first hinge member.
